(19) United States
(12) Patent Application Publication
(10) Pub. No.: US 2010/0178786 A1
(43) Pub. Date: Jul. 15, 2010

(54) Electric Device Assembly

(75) Inventor: Karl-Heinz Lux, Weikersheim (DE)

Correspondence Address: GUDRUN E. HUCKETT DRAUDT, SCHUBERTSTR. 15A, WUPPERTAL, 42289, DE

(73) Assignee: BARTEC GMBH, Bad Mergentheim (DE)

(21) Appl. No.: 12/687,928

(22) Filed: Jan. 15, 2010

(30) Foreign Application Priority Data
Jan. 15, 2009 (DE) 10 2009 005 051.5

(51) Int. Cl. H01R 13/62

(52) U.S. Cl. 439/261

(57) ABSTRACT

An electric device assembly has a frame housing provided with electric connectors and an assembly housing containing electric and/or electronic components and adapted to be inserted into the frame housing. A plug connector that has at least one contact tube and at least one contact pin engaging the at least one contact tube is provided. A lock system acting on the plug connector has an actuator that is pivotable about a pivot axis. The actuator is non-detachably secured on the frame housing by a blocking device. The blocking device has a blocking member arranged on a support wall of the frame housing. The blocking member engages a blocking member receptacle that is disposed on the actuator. The actuator is pivotably connected to the support wall by a bearing part received in a bearing receptacle in the support wall.

### BACKGROUND OF THE INVENTION

The invention relates to an electric device assembly with an assembly housing that contains electric and/or electronic components and is insertable into a frame housing.

It is an object of the present invention to further develop an electric device assembly of the aforementioned kind in such a way that with simple means a risk-free and safe exchange of the assembly housing is possible without having to switch off beforehand the operating device, or parts thereof, or to separate electric connecting lines.

### SUMMARY OF THE INVENTION

In accordance with the present invention, this is achieved in that the electric device assembly comprises a frame housing that has electric connectors, an assembly housing that contains electric and/or electronic components and is insertable into the frame housing, a plug connector that is provided with at least one contact tube and at least one contact pin engaging the contact tube, and a lock system that acts on the plug connector and comprises an actuator that is pivotable about a pivot axis.

In a preferred embodiment, the contact pin is correlated with a plug that is arranged on the bottom side of the assembly housing that is facing the frame housing.

The contact pin is surrounded by a circumferential wall of the plug that is arranged at a spacing to the contact pin.

The plug with the circumferential wall has an approximately rectangular shape in cross-section.

The contact pin of the plug is correlated with the electric or electronic components of the assembly housing.

The contact tube is correlated with a plug receptacle that is arranged on the topside of the frame housing that is facing the assembly housing.

The contact tube of the plug receptacle is surrounded by a boundary wall.

The plug receptacle with the boundary wall has in cross-section an approximately rectangular shape.

The contact tube of the plug receptacle is correlated with electric supply lines and electric outgoing lines.

The contact tube its arranged in an electrically non-conducting insulating body.

The insulating body with the contact tube is floatingly supported in the plug receptacle.

The insulating body comprises an insertion part that projects past the tube opening of the contact tube and has an insertion bore for the contact pin.

The insertion bore in the insertion part of the insulating body has a diameter that is slightly greater than the diameter of the contact pin.

Between the circumferential surface of the contact pin and the inner surface of the insertion bore a spark ignition-proof or flame-proof explosion protection gap is formed that fulfills the regulations of explosion protection.

The circumferential wall of the plug engages a slot-shaped cutout of the plug receptacle.

The frame housing has at least one support wall that rests against a sidewall of the assembly housing.

On the sidewall of the assembly housing at least one stay is arranged that is guided within a longitudinal groove that extends in the insertion direction of the assembly housing and is formed within the support wall of the frame housing.

The actuator of the lock system is secured on the frame housing by a blocking device in a non-releasable way, wherein the blocking device comprises a blocking member that is preferably formed on the support wall and engages a blocking member receptacle formed on the actuator.

The actuator of the lock system is pivotably supported on the support wall of the frame housing.

The pivotable connection of the actuator comprises at least one bearing part that is arranged in a bearing receptacle.

The bearing part is provided on the actuator and the bearing receptacle is provided in the support wall of the frame housing.

The lock system of the plug connector comprises at least one locking pin that engages an approximately semi-circular guide groove.

The locking pin is provided on the sidewall of the assembly housing and the guide groove is formed in the bearing part of the actuator.

The part-circular guide groove extends from an insertion opening that is provided on the circumferential rim of the bearing part approximately radially in the direction toward the pivot axis of the actuator.

The bearing receptacle in the support wall of the frame housing has an inlet opening for the locking pin which inlet opening, when the actuator is pivoted into a release position, is aligned with the insertion opening of the guide groove.

When the locking pin is inserted into the inlet opening and into the insertion opening of the guide groove, the assembly housing is moveable in the direction against the frame housing exclusively by pivoting the actuator.

After insertion of the locking pin into the insertion opening and a minimal pivoting of the actuator in the direction toward the locked position, the locking pin is positive-lockingly secured in the guide groove to prevent the locking pin from sliding out of the insertion opening of the guide groove.

After insertion of the locking pin into the insertion opening and minimal pivoting of the actuator in the direction toward the locked position, between the contact pin and the contact tube in the insulation body a minimum contact spacing is provided that fulfills the regulations of explosion protection.

After insertion of the locking pin into the insertion opening and pivoting of the actuator into the locked position, the contact pin engages the contact tube.

The actuator is secured in the locked position by an abutment that impacts on a locking cam to prevent accidental return pivoting into the release position.

The frame housing is detachably secured by means of a movably supported locking device on a support rail in the form of a cap rail or top hat rail that is in cross-section approximately U-shaped.

The locking device in the locked position of the actuator is secured against accidental movement by a locking edge resting against a locking edge of the actuator.

The oppositely positioned sidewalls of the assembly housing each are provided with a locking pin and a stay and the frame housing has two parallel and spaced apart support walls that each have a bearing receptacle with an inlet opening as well as a locking cam, a longitudinal groove, and a blocking member. The two support walls are connected by means of an end wall. The actuator is provided with two legs and a grip part connecting the two legs so that the actuator is an approximately U-shaped bracket. The two legs each are provided with a bearing part with guide groove and insertion opening; an abutment; a looking edge;

and a blocking member receptacle.

### BRIEF DESCRIPTION OF THE DRAWING

FIG. 1 is an exploded view of the electric device assembly according to the invention.

FIG. 2 shows the device assembly of FIG. 1 in a first mounting position, partially in section view.

FIG. 3 shows the device assembly of FIG. 2 in a section view.

FIG. 4 shows the device assembly of FIG. 1 in a second mounting position in a view similar to FIG. 2, partially in section view.

FIG. 5 shows the device assembly of FIG. 4 in a further mounting position, partially in section view.

FIG. 6 shows the device assembly of FIG. 5 in a section view.

FIG. 7 shows a detail view of the plug connector according to the detail VII of FIG. 6.

FIG. 8 shows the device assembly of FIG. 4 in the completed assembled state, partially in section.

FIG. 9 shows the device assembly according to FIG. 8 in section illustration.

FIG. 10 shows a detail view of the plug connector according to detail X of FIG. 9 in an enlarged section illustration.

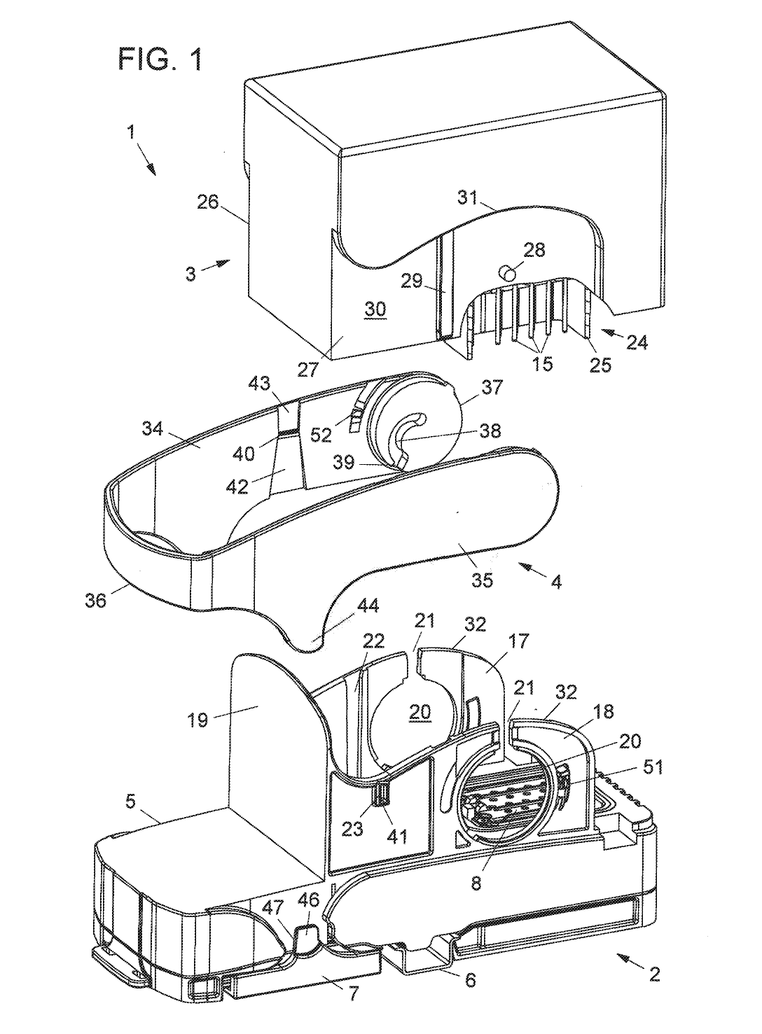

### DESCRIPTION OF THE PREFERRED EMBODIMENTS

The electric device assembly 1 is provided for use in dangerous areas, in particular in explosion-hazardous areas, and comprises a frame housing 2, an assembly housing 3, and an actuator 4 that belongs to a releasable lock system for locking the assembly housing 3 that is insertable into the frame housing 2.

The frame housing 2 has a base member 5 releasably attached to a support rail (cap rail or top hat rail) 6 that is approximately U-shaped in cross-section. For providing the releasable connection of the frame housing 2 on the base member 5 a locking device 7 is provided that is supported on the base member 5 so as to be movably transversely to the longitudinal direction of the cap rail 6. On the side of the rail 6 opposite the locking device 7 the base member 5 has a plug receptacle 8 with several contact tubes 9 that are spaced apart from one another. The contact tubes 9 are surrounded by a boundary wall 10 that is expediently formed of four walls with neighboring ones positioned at a right angle to one another so that the plug receptacle 8 in cross-section is substantially rectangular.

Each individual contact tube 9 is located in an electrically non-conducting insulation body 11 that may be embodied as a cylinder of approximately circular cross-section. The insulation bodies 11 can be significantly longer than, preferably approximately twice as long as, the contact tubes 9 that are arranged expediently in the lower part of the insulation bodies 11 so that an insertion part 12 of the insulation bodies 11 projects significant past the tube opening 13 of the contact tubes 9. The insertion part 12 of the insulation bodies 11 has an insertion bore 14 that is arranged coaxially to the contact tube 9 and into which a contact pin 15 is insertable. In order to facilitate introduction of the contact pin 15 into the insertion bore 14, the insulation bodies 11 with the contact tubes 9 can be floatingly supported in the plug receptacle 8. On the contact tubes 9 moreover a sleeve-shaped connecting part 16 can be formed which project from the plug receptacle 8 and to which electrical lines are connected, for example, by soldering or crimping.

On the topside of the base member 5 support walls 17, 18 that are parallel to and spaced apart from one another are provided and connected to one another by means of transversely arranged end wall 19 so that a receiving space is provided that is delimited on three sides. On each of the two support walls 17, 18 there is a circular bearing receptacle 20; the bearing receptacles 20 are positioned opposite one another. Each bearing receptacle 20 comprises an inlet opening 21 that is formed in the support walls 17, 18 as a slot-shaped cutout. Moreover, the support walls 17, 18 are provided at their inner sides with oppositely positioned longitudinal grooves 22 that extends in the insertion direction of the assembly housing 3. The exterior sides of the support walls 17, 18 each have oppositely positioned locking cams 23. Moreover, the support walls 17, 18 each have a blocking member 51 that is arranged adjacent to the circumferential area of the bearing receptacles 20.

The assembly housing 3 is substantially embodied as a rectangular body and has at its bottom side facing the frame housing 2 a plug 24 mating with the plug receptacle 8 is provided. The plug 24 is delimited by a circumferential wall 25 that is formed of four wall parts with neighboring ones positioned at a right angle relative to one another, respectively. The plug 24 with the circumferential wall 25 is thus in cross-section substantially rectangular. The circumferential wall 25 surrounds the contact pins 15 that are positioned at a spacing to one another and are connected electrically conductingly with electric or electronic components arranged within the assembly housing 3. The diameter of the contact pins 15 is selected such that it is minimally smaller than the diameter of the insertion bore 14 of the insulation bodies 11 in the frame part 2. When the plug 24 is inserted into the plug receptacle 8, between the circumferential surface of the contact pins 15 and the inner surface of the insertion bores 14 there is a flame-proof or spark ignition-proof gap 33 that is defined by DIN EN 50018 and DIN EN 60079.

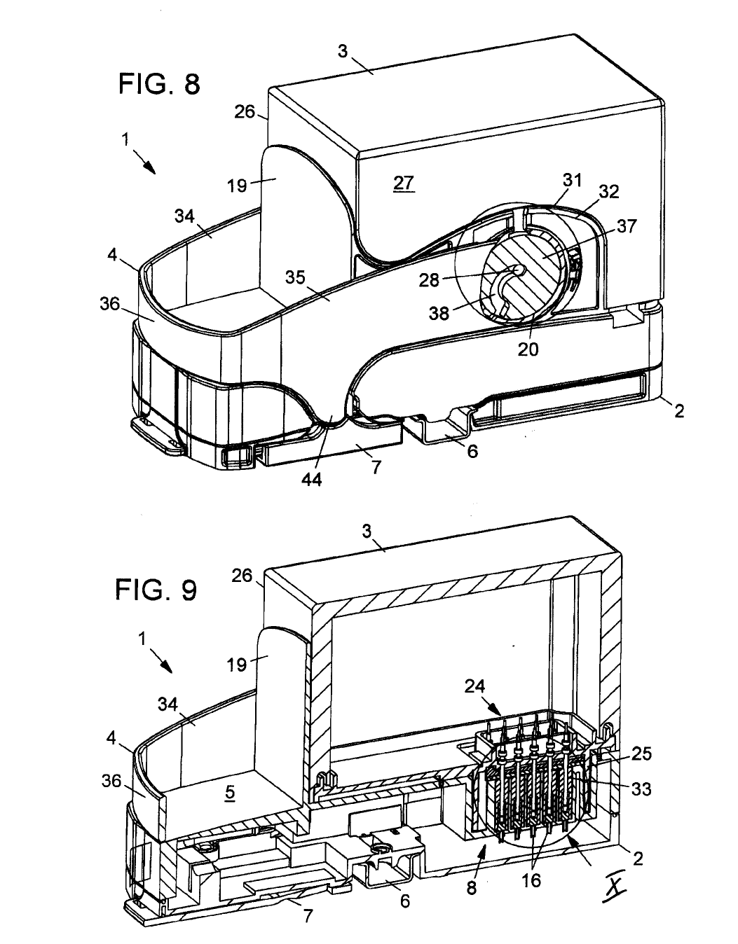

On spaced apart parallel sidewalls 26, 27 of the assembly housing 3 there is a locking pin 28, respectively; these locking pins 28 are positioned opposite one another and project in opposite directions and outwardly. Moreover, on the exterior sides of the sidewalls 26, 27 a stay 29 is provided, respectively, and the stays 29 are positioned opposite one another. The wall section 30 of the sidewalls 26, 27 is somewhat inwardly recessed and delimited by an approximately wave-shaped edge contour 31. In accordance with this edge contour 31 the outer rims of the support walls 17, 18 also have an approximately wave-shaped end face contour 32 that matches the edge contour 31 in the completely assembled state illustrated in FIG. 8. The depth of the recessed wall sections 30 corresponds approximately to the thickness of the support walls 17, 18 that rest against the wall sections 30.

The actuator 4 has two spaced apart, parallel legs 34, 35 and a grip part 36 that is slightly curved and connects the legs 34, 35 so that the actuator 4 is substantially embodied as a U-shaped bracket. The actuator 4 is arranged on the support walls 17, 18 of the frame housing 2 and is pivotably supported. For this purpose, a bearing part 37 is arranged on the inner faces of the legs 34, 35 at their free ends, respectively, and these bearings parts 37 are positioned mirror-symmetrically opposite one another and each have a guide groove 38. The bearing parts 37 are embodied as circular disks and are positive-lockingly supported in the bearing receptacles 20 of the support walls 17, 18 wherein the center axes of the annular bearing parts 37 form the pivot axis of the actuator 4.

Adjacent to the circumferential area of the bearing parts 37 on the legs 34, 35 of the actuator 4 a blocking member receptacle 52 is formed, respectively. The blocking members 51 of the support walls 17, 18 engage positive-lockingly these receptacles 32 in such a way that the actuator 4 is secured captively in its end positions as well as during its pivot movement and cannot be removed from the support walls.

The guide grooves 38 are embodied approximately radially in the bearing parts 37 and extend from an insertion opening 39 formed at the circumferential rim of the bearing parts 37 approximately semi-circularly in the direction toward the center axis of the bearing part 37. The width of the guide grooves 38 is sized such that they are approximately identical or only slightly greater than the diameter of the locking pins 28 so that the latter are guided substantially without play in the guide grooves 38. Moreover, on the inner sides of the two legs 34, 35 of the actuator 4 there are two abutments 40 that are mirror-symmetrically positioned opposite one another and rest against a stop 41 of the locking cam 23. A ramp 42 for the locking cam 23 is arranged in front of the abutments 40 and a recess 43 is arranged behind the abutments 40, respectively. Moreover, the actuator 4 has on its legs 34, 35 nose-shaped projections 44 that have on their inner sides mirror-symmetrically arranged opposed locking edges 45. In the locked position of the actuator 4 the projections 44 engage across a wall part 46 formed on the oppositely positioned sides of the locking device 7. The wall parts 46 have a locking edge 47 resting against the locking edge 45 of the projection 44 so that an accidental displacement or movement of the locking device 7 into a release position is prevented.

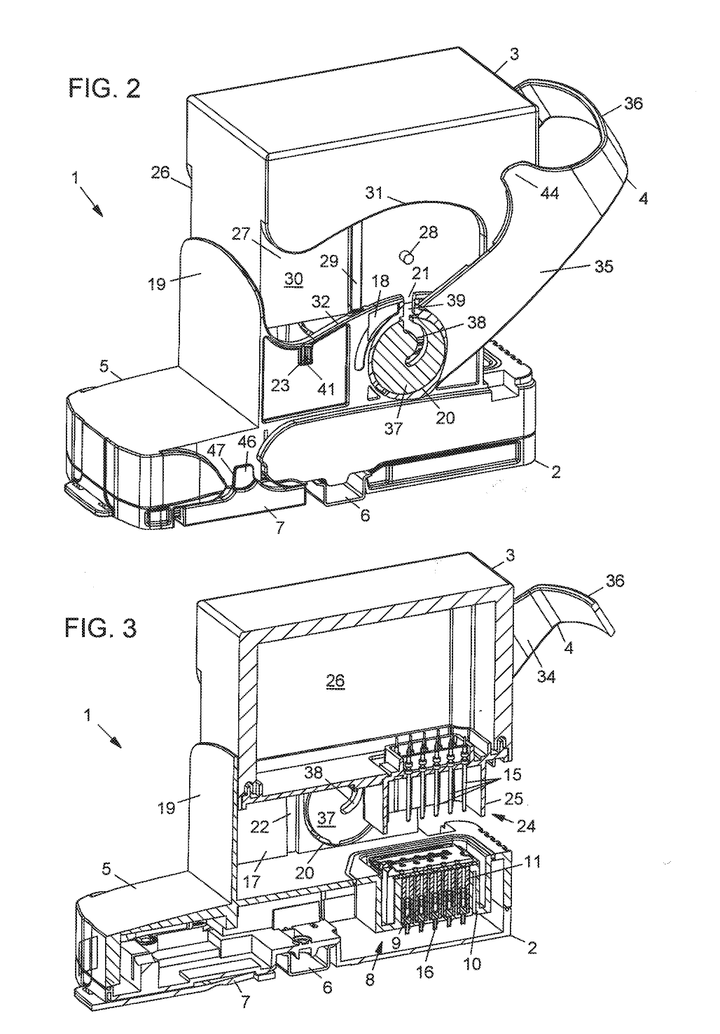

In FIGS. 2 and 3 the assembly housing 3 of the device assembly 1, whose frame housing 2 is attached by means of the locking device 7 on the cap rail 6, is in a first mounting position. The actuator 4 is pivoted in clockwise direction all the way to the rear into a limited release position wherein the inlet openings 21 of the support walls 17, 18 and the insertion openings 39 of the bearing parts 37 are congruently positioned. The assembly housing 3 is inserted into the receiving space of the frame housing 2 that is delimited on three sides by the support walls 17, 18 and the end wall 19 in such away that the stays 29 are positioned closely above the longitudinal grooves 22 and the locking pins 28 are positioned at a somewhat greater spacing above the inlet and insertion openings 21, 39. FIG. 3 shows that in this first mounting position the spacing of the assembly housing 3 above the frame housing 2 is so large that the plug 24 also has a definite spacing relative to the plug receptacle 8 of the frame housing 2.

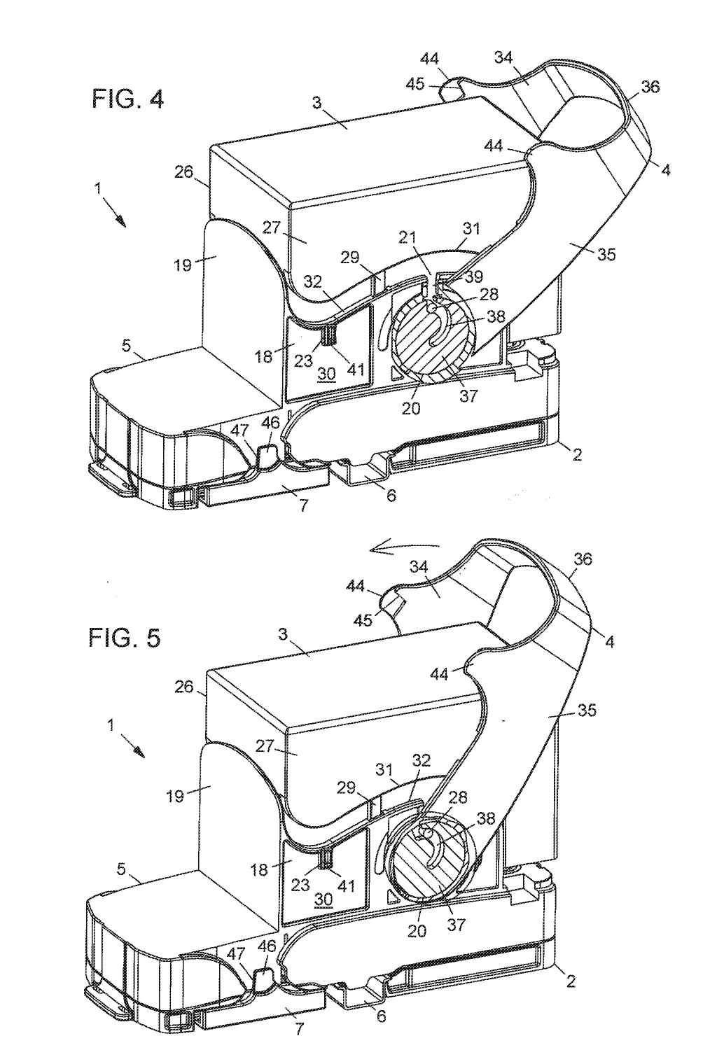

FIG. 4 shows that the assembly housing 3 relative to the illustrations of FIGS. 2 and 3 has been pressed or pushed farther in the downward direction into the receiving space of the frame housing 2 wherein the stays 29 are guided substantially without play in the longitudinal grooves 22 and in this way ensure a proper displacement into the illustrated second mounting position. The actuator 4 is still in its release position pivoted all the way to the rear and the locking pins 28 have passed through the inlet opening 21 and the insertion openings 39 and are now located at the beginning of the part-circular guide grooves 38 of the bearing parts 37. Further downward pressing or downward pushing of the assembly housing 3 in the direction toward the frame housing 2 is no longer possible. The assembly housing 3 can be moved only by pivoting of the actuator 4 farther in the direction toward the frame housing 2.

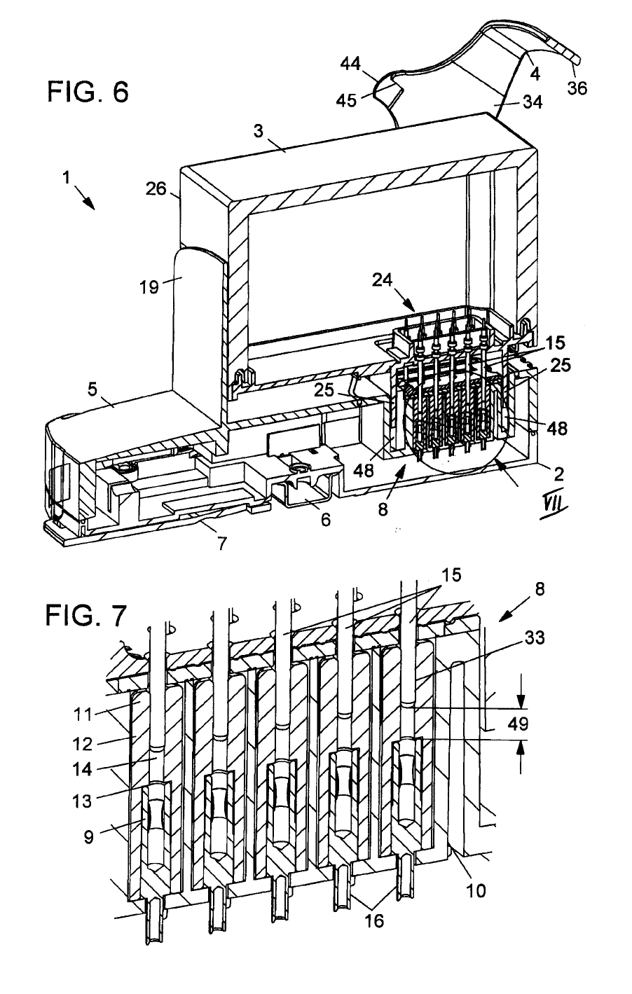

The FIGS. 5 and 6 disclose that the actuator 4 in comparison to the illustration of FIG. 4 has been pivoted to some degree in the counterclockwise direction. According to FIG. 5, the insertion openings 39 of the bearing parts 37 are no longer congruently positioned with the inlet openings 21 of the support walls 17, 18 so that the locking pins 28 in the guide grooves 38 are now engaged from above. In this mounting position the assembly housing 3 is already secured by the positive-locking engagement of the locking pins 28 in such away that, for example, when an explosion-like counter pressure occurs, the assembly housing 3 can no longer be pushed upwardly away from the frame housing 2 in upward direction.

As can be seen in FIG. 6, in this mounting position the plug 24 of the assembly housing 3 is already partially inserted into the plug receptacle 8 of the frame housing 2. In this way, the circumferential wall 25 of the plug 24 is inserted approximately halfway into the slot-shaped cutout 48 that is preferably formed in the boundary wall 10 of the plug receptacle 8. The enlarged illustration of FIG. 7 shows that the contact pins 15 are located initially only in the insertion bores 14 of the insulation bodies 11 and are not yet interacting with the contact tubes 9. Between the free ends of the contact pins 15 and the tube openings 13 of the contact tubes 9 there is an axial minimum contact spacing 49 that corresponds to the regulations according to DIN EN 50018 and DIN EN 60079.

In FIGS. 8 and 9 the final assembled position of the device assembly 1 is illustrated. The actuator 4 has been pivoted in counterclockwise direction and is now in its horizontal locked position. During pivoting, shortly before reaching the locked position, the ramps 42 of the actuator 4 glide across the locking cams 23 of the support walls 17, 18 until at the end of the pivot movement the locking cams 23 snap (click) into the recesses 43 of the actuator 4 so that the abutments 40 will rest against the stops 41 of the locking cams 23. In this way, an accidental upward pivoting of the actuator 4 in the clockwise direction is reliably prevented and a stable fixation of the locked position is ensured. Moreover, the pivoting action of the actuator 4 causes the locking pins 28 that are secured in the semi-circular guide grooves 38 in a positive-locking way and are therefore subject to a forced guiding action are moved in downward direction toward the frame housing 2 and also toward the end of the guide grooves 38. In this final position the locking pins 28 are preferably coaxial to the pivot axis of the actuator 4. Since the locking pins 28 are stationarily arranged on the assembly housing 3, the latter, of course, has also been moved in the downward direction against the frame housing 2 into its end position. In the illustrated locked position of the actuator 4 the projections 44 engage across the wall parts 46 of the locking device 7. In this way, the locking edges 47 of the wall parts 46 rest against the locking edge 45 of the projections 44 and prevent thus the horizontal displacement of the locking device 7 in the plane of the base body 5.

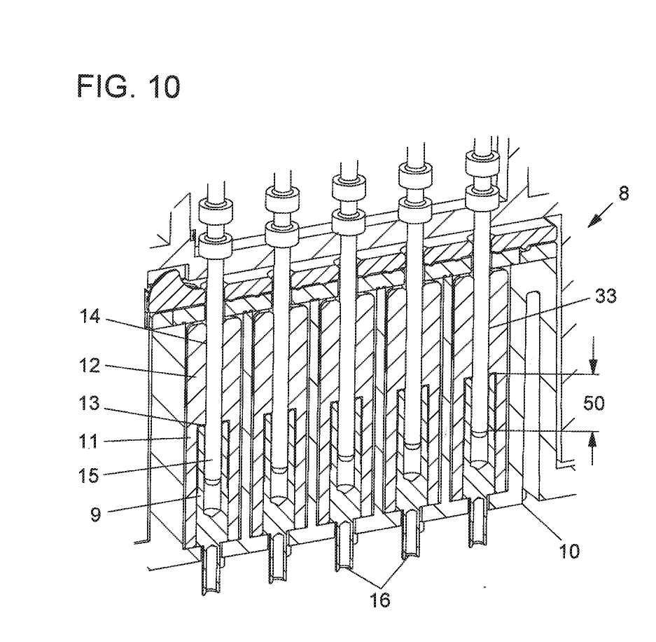

FIG. 9 shows that the circumferential wall 25 of the plug 24 is now completely inserted to the bottom of the slot-shaped cutout 48 of the plug receptacle 8. Moreover, FIG. 9 and in particular also the enlarged illustration of FIG. 10 show that the contact pins 15 of the plug 24 are inserted into the contact tubes 9 of the plug receptacle 8 across an axial minimum contact distance 50 so that a permanent reliable contact is ensured.

When the assembly housing 3, for example, in case of a defect during operation must be exchanged, the afore described mounting process is to be carried out in reverse. This means that first the securing action of the locked position of the actuator 4 must be released or canceled. Then the actuator 4 is to be pivoted in clockwise direction into the release position illustrated in FIG. 2 wherein the assembly housing 3, by means of the eccentric guiding action for the locking pins, is moved away from the frame housing 2 in the upward direction and the plug connector is decoupled. After reaching the release position of the actuator 4, the assembly housing 3 can be pulled manually in the upward direction out of the receiving space of the frame housing 2 and a new one can be inserted.

One advantage of the device assembly 1 according to the invention resides in that in critical explosion-hazardous environments the active assembly, i.e., the assembly housing 3 with the electric and/or electronic components, can be exchanged in the operating state without any risk or danger and without having to switch off the facility. Therefore, no connections that are fixedly realized by connecting lines must be interrupted; all connections remain intact within the base housing, i.e., the frame housing 2. Neither during insertion nor during removal of the assembly housing 3, sparks that are produced in the interior of the plug connector can cause ignition of an explosive surrounding atmosphere because of the described measures so that, as a whole, a great safety standard is provided.

The specification incorporates by reference the entire disclosure of German priority document 10 2009 005 051.5 having a filing date of Jan. 15, 2009.

While specific embodiments of the invention have been shown and described in detail to illustrate the inventive principles, it will be understood that the invention may be embodied otherwise without departing from such principles.

What is claimed is:

1. An electric device assembly comprising:
a frame housing provided with electric connectors;
an assembly housing containing electric and/or electronic components and adapted to be inserted into said frame housing;
a plug connector comprising at least one contact tube and at least one contact pin engaging said at least one contact tube;
a lock system acting on said plug connector and comprising an actuator that is pivotable about a pivot axis.

2. The electric device assembly according to claim 1, wherein said plug connector comprises a plug and said at least one contact pin is arranged in said plug, wherein said plug is arranged on a bottom side of said assembly housing, which bottom side is facing said frame housing, wherein said plug comprises a circumferential wall surrounding said at least one contact pin at a spacing.

3. The electric device assembly according to claim 2, wherein said at least one contact pin is assigned to the electric and/or electronic components contained in said assembly housing and wherein said art least one contact tube is assigned to electric supply lines and electric outgoing lines.

4. The electric device assembly according to claim 2, wherein said plug connector comprises a plug receptacle mating with said plug, wherein said at least one contact tube is arranged in said plug receptacle, wherein said plug receptacle is arranged on a top side of said frame housing which top side is facing said assembly housing, wherein said plug receptacle has a boundary wall surrounding said at least one contact tube.

5. The electric device assembly according to claim 4, wherein the plug receptacle comprises at least one electrically non-conducting insulation body and wherein said at least one contact tube is arranged in said at least one insulation body and said at least one insulation body together with said at least one contact tube is floatingly arranged in said plug receptacle.

6. The electric device assembly according to claim 5, wherein said at least one insulation body comprises an insertion part that projects past a tube opening of said
contact tube, wherein said insertion part has an insertion bore for said at least one contact pin, wherein between a circumferential surface of said at least one contact pin and an inner surface of said insertion bore a spark ignition-proof explosion protection gap in accordance with explosion protection regulations is formed.

7. The electric device assembly according to claim 4, wherein said circumferential wall of said plug engages a slot-shaped cutout of said plug receptacle.

8. The electric device assembly according to claim 1, wherein said frame housing comprises at least one support wall provided with a longitudinal groove extending in an insertion direction of said assembly housing, wherein said at least one support wall rests against a sidewall of said assembly housing, wherein said sidewall of said assembly housing has at least one stay that is guided in said at least one longitudinal groove.

9. The electric device assembly according to claim 8, wherein said actuator is non-detachably secured on said frame housing by a blocking device, wherein said blocking device comprises a blocking member that is arranged on said at least one support wall and engages a blocking member receptacle that is disposed on said actuator, wherein said actuator is pivotably connected to said at least one support wall by a bearing part received in a bearing receptacle.

10. The electric device according to claim 9, wherein said lock system comprises at least one locking pin disposed on said sidewall of said assembly housing and at least one approximately semi-circular guide groove provided on said bearing part, wherein said at least one guide groove has an insertion opening disposed on a circumferential rim of said bearing part and extends from said insertion opening approximately in a radial direction toward a pivot axis of said actuator, wherein said at least one locking pin engages said at least one guide groove.

11. The electric device according to claim 10, wherein said bearing receptacle is arranged on said at least one support wall and has an inlet opening for said at least locking pin, wherein said inlet opening in a release position of said actuator is aligned with said insertion opening of said at least one guide groove, wherein, when said at least one locking pin is inserted into said insertion opening through said inlet opening, said assembly housing is moveable against said frame housing exclusively by pivoting said actuator.

12. The electric device according to claim 11, wherein, after insertion of said at least one locking pin into said insertion opening and minimal pivoting of said actuator in a direction of a locked position of said actuator, said at least one locking pin is secured positively against sliding out of said at least one guide groove through said insertion opening and between said at least one contact pin and said at least one contact tube, arranged in an insulation body, a minimum contact spacing in accordance with explosion protection regulations is provided.

13. The electric device according to claim 11, wherein, after insertion of said at least one locking pin into said insertion opening and pivoting of said actuator into a locked position of said actuator, said at least one contact pin engages said at least one contact tube and said actuator in said locked position is secured against accidental return into a release position of said actuator by an abutment of said actuator contacting a locking cam disposed on said frame housing.

14. The electric device according to claim 13, wherein said frame housing has a slidably supported locking device for securing said frame housing on a support rail, wherein said locking device in said locked position of said actuator is secured against accidental displacement by a locking edge engaging a locking edge of said actuator.

15. The electric device according to claim 1, wherein:
said assembly housing has opposed sidewalls and each of said sidewalls has a locking pin and a stay;
wherein said frame housing has two parallel, spaced apart support walls and an end wall connecting one end of said support walls to one another;
wherein said support walls each have a bearing receptacle with an inlet opening and further have a locking cam, a longitudinal groove, and a blocking member;
wherein said actuator is a U-shaped bracket comprising two legs and a grip part connecting said two legs;
wherein said two legs each have a bearing part with a guide groove that has an insertion opening, wherein said bearing part engage said bearing receptacle, respectively;
wherein said two legs each have an abutment interacting with said locking cam;
wherein said two legs each have a locking edge; and
wherein said two legs each have blocking member receptacle receiving said blocking member, respectively.
